(19) United States
(12) Patent Application Publication
(10) Pub. No.: US 2003/0079305 A1
(43) Pub. Date: May 1, 2003

(54) Electric toothbrush

(76) Inventors: Daisuke Takahata, Higashimatsuyama-shi (JP); Hidekiyo Suginoya, Kumagaya-shi (JP); Hirohiko Maruyama, Osaka-shi (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/268,094

(22) Filed: Oct. 10, 2002

(30) Foreign Application Priority Data
Oct. 10, 2001 (JP) 2001-312457
Mar. 11, 2002 (JP) 2002-65672
Mar. 11, 2002 (JP) 2002-65673

(51) Int. Cl. A61C 17/34

(52) U.S. Cl. 15/22.1; 15/22.2; 15/28

(57) ABSTRACT

An electric toothbrush is disclosed in which a brush body is simultaneously oscillated and reciprocated for brushing every gap between teeth. The electric toothbrush includes a casing main body, an arm extending above the casing main body, a brush body arranged in a top end of the arm, and an ultrasonic motor arranged in a top end inside of the arm for driving the brush body. An output shaft of the ultrasonic motor and the brush body are connected to each other by connecting piece. In this construction, the brush body is movable along the output shaft. The electric toothbrush further includes a reciprocating mechanism, which is provided between the arm and a holder of the brush body, and which reciprocates the brush body.

### BACKGROUND AND SUMMARY OF THE INVENTION

This application claims the priority of Japanese patent applications No. 2001-312457, filed Oct. 10, 2001; No. 2002-65672, filed Mar. 11, 2002 and No. 2002-65673, filed Mar. 11, 2002, the disclosures of which are expressly incorporated by reference herein.

This invention relates to an electric toothbrush which is structured in a manner such that an ultrasonic motor drives a brush body disposed in a top end of an arm.

Some conventional electric toothbrushes are equipped with a casing main body which performs as a grip and contains batteries and a motor, and a brush unit which is detachably attached to a top end of the casing main body. The brush unit includes a hollow arm, a brush body which is integrated into a top end of the arm, and a power-transmission system which is arranged in the arm to transmit driving force from the motor to the brush body. A lower end of the arm is inserted into an upper end of the casing main body, and an input shaft of the power-transmission system is therefore engaged with a driving shaft provided in the casing main body.

The prior art electric toothbrush is composed in a manner such that the power-transmission system which is arranged in the brush unit transmits power from the motor to the brush body. For this reason, power losses or unwanted vibration is unavoidably accompanied with the power transmission. Furthermore, since the power-transmission system is integrated in each brush unit, the cost of replacing or purchasing the brush unit will be comparatively high.

The electric toothbrush is functionally required to simultaneously oscillate the brush body around a shaft of the brush body and reciprocate it along the shaft for brushing teeth of a user. Thus, one of the techniques for giving three-dimensional driving to the brush body of the electric toothbrush is well known in Japanese patent publication No.2804940. However, according to the disclosure of this patent, the motor is also contained in the casing main body, and rotational power from the motor is converted into oscillating power and reciprocating power, and then transmitted to the brush body by the power-transmission system provided in the arm. Consequently, this patent also has the above-described disadvantage.

Moreover, the power-transmission system arranged in the arm of the above electric toothbrush includes a straight-line rod, so that the arm has to be designed in a straight-line shape. This structure has forced a user to widely open his or her mouth, or awkwardly incline his or her head and arm in an uncomfortable posture when the user brushes his or her back teeth, or backsides of his or her teeth.

Further, the ultrasonic motor can be downsized considering its power, and an electric toothbrush having a structure that the ultrasonic motor as a driving source, oscillates the brush body in normal and reverse rotational directions is well known in Japanese laid-open application publication No.7-322920. Although the conventional art discloses the structure that the ultrasonic motor is arranged in a top part of the arm, it does not refer to the way that the ultrasonic motor concretely oscillates the brush body. Besides, when bristles have been worn out from use, the brush body including the ultrasonic motor has to be replaced in this structure. This is considerably expensive, but the conventional art has not yet resolved this problem.

The present invention is directed to overcoming one or more of problems set forth above. It is an aspect of certain preferred embodiments of the present invention to provide an electric toothbrush which is constituted in a manner such that an ultrasonic motor arranged in a top end of an arm drives a brush body, thereby preventing losses of power in a power-transmission system, and reducing unwanted vibration and motor noise for enabling a user to quietly brush his or her tooth.

It is a further aspect of certain preferred embodiments of the present invention to provide an electric toothbrush that a brush body alone can be replaced. Thus, the cost for replacing or purchasing the brush body can be decreased.

Still another aspect of certain preferred embodiments of the present invention is to provide an electric toothbrush that a brush body is simultaneously oscillated and reciprocated, thereby effectively cleaning gaps between teeth or gum lines of a user.

Yet another aspect of certain preferred embodiments of the present invention is to provide an electric toothbrush including an arm which is formed in a curved shape to allow a user to easily brush his or her back teeth, or backsides as well as foresides of his or her teeth brush in a relaxed posture.

Another aspect of certain preferred embodiments of the present invention is to provide an electric toothbrush that an ultrasonic motor is easily mounted in an arm, and the inside of a brush body is surely kept watertight.

In accordance with one embodiment of the present invention, an electric toothbrush is set forth. It comprises a casing main body as a grip, an arm which extends above the casing main body, a brush body which is arranged in a top front side of the arm, and an ultrasonic motor which is arranged in a top end inside the arm and oscillates the brush body. The electric toothbrush further comprises a reciprocating mechanism which is arranged between the arm and the brush body and which oscillates and reciprocates the brush body.

When so constructed, the casing main body contains batteries for supplying power to the ultrasonic motor, and said casing main body further includes changeover buttons for switching on and off a current carrying circuit of the ultrasonic motor.

In this manner, the ultrasonic motor arranged in the top end inside of the arm directly drives the brush body. This eliminates the need for providing a power-transmission system in the arm for transmitting the power from the motor to the brush body, and simplifies the entire structure of the electric toothbrush. Then, this can decrease the cost for replacing or purchasing the brush body and cut production costs of the electric toothbrush. Besides, driving power is transmitted without power losses in this constitution, which makes it possible to drive the brush body with lower output power, and reduce power consumption of batteries.

Further, the ultrasonic motor oscillates the brush body at a higher speed than a normal type motor does, so that the brush body can brush teeth more effectively. In addition, since the ultrasonic motor is made in a smaller size than the normal type motor having the same output power, the ultrasonic motor can be mounted in a small space of a top end inside of the arm. For this reason, the brush body, which is inserted into a user's mouth, can be miniaturized. This eliminates the uncomfortable feeling for the user in brushing of teeth.

Furthermore, the brush body makes three-dimensional movements of oscillation and reciprocation, thereby effectively cleaning every gap between teeth and gum lines as well as the facade of teeth and gum of the user.

In accordance with even a further embodiment of the present invention, an electric toothbrush is set forth. It comprises a casing main body as a grip, an arm which extends above the casing main body, a brush body which is arranged in a top front side of the arm, and an ultrasonic motor which is arranged in a top end inside of the arm and oscillates the brush body. The arm is curved toward a direction that the brush body is projected.

In this manner, since the arm is curved, a user can easily brush his or her back teeth, or backsides as well as foresides of his or her teeth in a relaxed posture without widely opening his or her mouth. In addition, the curved shape increases strength of the arm, so that even if the user presses the brush body hard against his or her teeth or gum, the arm can be prevented from being deformed. Thus, the user can freely handle the brush body.

In accordance with even a further embodiment of the present invention, an electric toothbrush is set forth. It comprises a casing main body as a grip, an arm which extends above the casing main body, a brush body which is arranged in a top front side of the arm, an ultrasonic motor which is arranged in a top end inside of the arm and which oscillates the brush body, and a connecting piece which is fixed to an output shaft of the ultrasonic motor. The brush body is detachably attached to the connecting piece.

In this manner, the user can easily attach and detach the brush body to and from the arm through one-touch operation. Besides, if bristles have worn out from use, the user can replace the brush body alone. This will reduce the cost for replacing or purchasing the brush body, and the economic burden of the user.

Other objects, advantages and novel features of the present invention will become apparent from the following detailed description of the invention when considered in conjunction with the accompanying drawings.

### BRIEF DESCRIPTION OF THE DRAWINGS

FIG. 1 shows in a longitudinal sectional side view, a main part of an electric toothbrush in accordance with a first embodiment of the present invention;

FIG. 2 shows in a side view, the electric toothbrush in accordance with the first embodiment of the invention;

FIG. 3 shows in an exploded sectional view, a brush body, which is separated from a juncture member, in accordance with the invention in which a brush body is separated;

FIG. 4 shows in a longitudinal sectional side view, the brush body in a forward position, in accordance with the first embodiment of the invention;

FIG. 5 shows a view taken along line A-A of FIG. 1;

FIG. 6 shows in a longitudinal sectional side view, a main part of an electric toothbrush in accordance with a second embodiment of the present invention;

FIG. 7 shows in a longitudinal sectional side view, a main part of an electric toothbrush in accordance with a third embodiment of the present invention;

FIG. 8 shows in a longitudinal sectional side view, a main part of an electric toothbrush in accordance with a fourth embodiment of the present invention;

FIG. 9 shows in a longitudinal sectional side view, a main part of an electric toothbrush in accordance with a fifth embodiment of the present invention;

FIG. 10 shows a side view, part of the electric toothbrush in accordance with a sixth embodiment of the invention;

FIG. 11A shows in a longitudinal sectional side view, a brush body, which is separated from a juncture member in accordance with the sixth embodiment of the invention;

FIG. 11B shows in an enlarged view, a connection between a juncture member and a connecting piece of the brush body depicted in FIG. 11A;

FIG. 12 shows in an exploded perspective view, an arm and a brush body in accordance with the sixth embodiment of the invention;

FIG. 13 shows in a longitudinal sectional side view, the brush body, which is fixed in the arm in accordance with the sixth embodiment of the invention;

FIG. 14 shows a view taken along line B-B of FIG. 13 showing a motion of the brush body in accordance with the sixth embodiment of the invention;

FIG. 15 shows in a side view, an electric toothbrush in accordance with a seventh embodiment of the invention;

FIG. 16A shows in a side view, an electric toothbrush in accordance with an eighth embodiment of the invention;

FIG. 16B shows in an enlarged view, a connection between an arm base and a motor case of the electric toothbrush depicted in FIG. 16A;

FIG. 17 shows in a side view, a main part of an electric toothbrush in accordance with a ninth embodiment of the invention;

FIG. 18 shows in a sectional view, an arm and a brush body in accordance with a tenth embodiment of the invention;

FIG. 19 shows in a sectional view, an arm and a brush body in accordance with an eleventh embodiment of the invention;

FIG. 20 shows in a sectional view, an arm and a brush body in accordance with a twelfth embodiment of the invention; and

FIG. 21 shows in a sectional view, an arm and a brush body in accordance with a thirteenth embodiment of the invention.

### DETAILED DESCIRPTION OF THE DRAWINGS

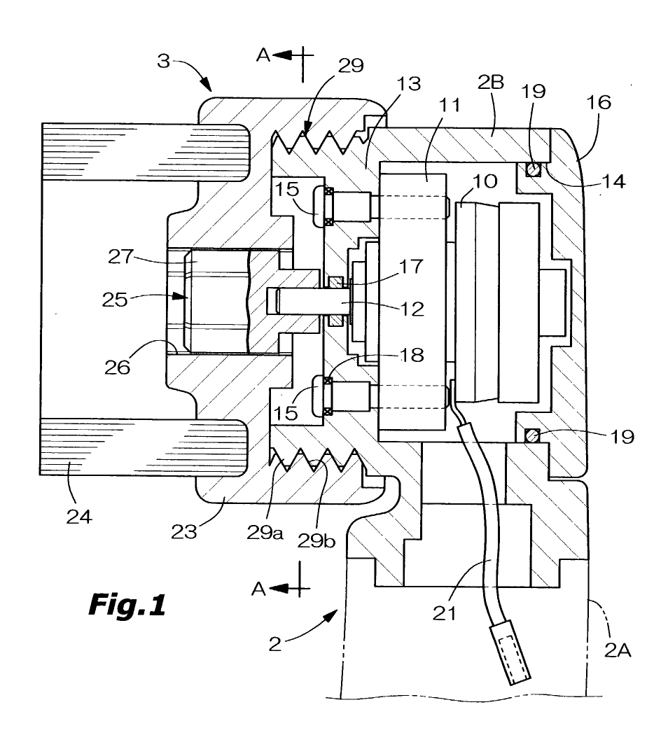

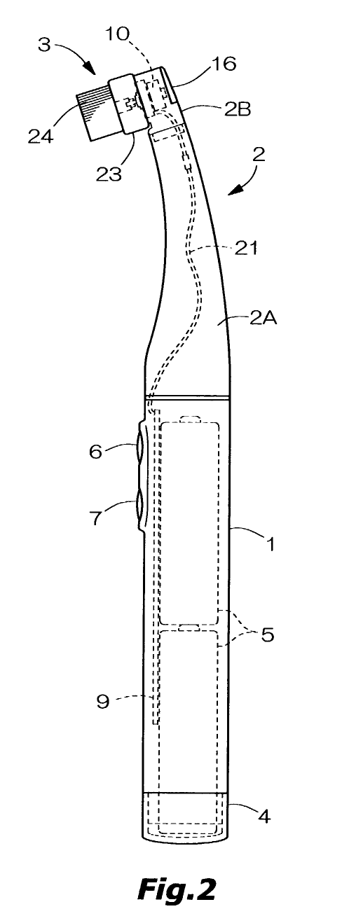

FIGS. 1-5 show an electric toothbrush in accordance with a first embodiment of the present invention. Referring to FIG. 2, the electric toothbrush comprises a casing main body 1 which a user holds, an arm 2 which extends above the casing main body 1, and a brush body 3 which is arranged so as to extend frontward from an upper end of arm 2.

Casing main body 1 includes a hollow-body plastic molding formed like a cylinder. A proximal end of arm 2 is fixed in an upper end of casing main body 1. A lower end of casing main body 1 is open, but watertightly closed by a battery lid 4. Casing main body 1 contains plural batteries 5, and a circuit board 9 on which a control circuit is mounted. A user can attach and detach battery lid 4 to and from casing main body 1 for battery replacement or maintenance.

Casing main body 1 is also provided in its upper front surface with an ON-button 6 for switching on a current-carrying circuit, and an OFF-button 7 for switching off the current-carrying circuit. Primary batteries or secondary batteries can be used as batteries 5.

Arm 2 includes an arm base 2A which makes up a larger part of arm 2 and a motor case 2B which is fixed in an upper end of arm base 2A. Arm base 2A, made of plastic, is formed like a hollow cylinder, the diameter of which gradually becomes smaller toward an upper end thereof. Due to the curve of arm base 2A, arm 2 is projectingly angled in a direction of brush body 3. A pivot shaft of brush body 3 is directed downward with a slant. This structure enables the user to easily brush his or her teeth in a relaxed posture without widely opening his or her mouth.

Motor case 2B is formed in a plastic hollow body in which an ultrasonic motor 10 for driving brush body 3 is disposed. Ultrasonic motor 10 oscillates brush body 3 in normal and reverse rotational directions. Ultrasonic motor 10 is fixed by a juncture member 13 which is projectively formed in a hollow body on a front side of motor case 2B. Ultrasonic motor 10 has an output shaft 12 which sticks out of the front surface of juncture member 13.

Ultrasonic motor 10 is incorporated inside motor case 2B through a loading gate 14 which is arranged in a rear side of motor case 2B.

More specifically, referring to FIG. 1, a flange 11 of ultrasonic motor 10 is applied to an inner surface of juncture member 13, and screws 15 are screwed from outside of the front surface of juncture member 13. Screws 15 tighten flange 11 onto the inner surface of juncture member 13, thereby fastening ultrasonic motor 10 to juncture member 13 in motor case 2B. In this state, spaces between juncture member 13 and output shaft 12, screws 15 and a cover 16 covering the loading gate 14 are water-tightly sealed by gaskets 17, 18 and 19, respectively. Ultrasonic motor 10 and circuit board 9 are connected to each other through a lead 21 running in arm 2.

Brush body 3 includes a plastic holder 23, formed like a cylinder, and bristles 24 which are planted in a ring shape. Output shaft 12 of ultrasonic motor 10 is fixed to a connecting piece 25. Here, brush body 3 is also connected to connecting piece 25 and moved in a direction along output shaft 12.

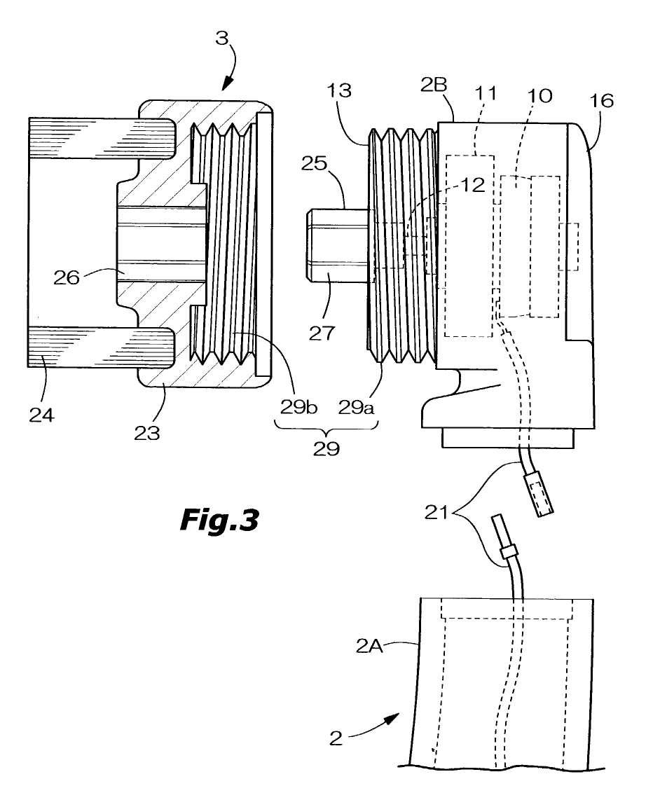

FIGS. 3 and 5 depict a constitution that brush body 3 is mounted to connecting piece 25. The holder 23 has a hexagonal driving aperture 26 which is formed in a manner of going through in a back-and-forth direction in an inner center of holder 23 while connecting piece 25 has a hexagonal driving shaft 27 which is provided on a periphery of connecting piece 25. When driving shaft 27 is inserted into driving aperture 26, brush body 3 is connected to output shaft 12 through connecting piece 25. This enables ultrasonic motor 10 to oscillate brush body 3.

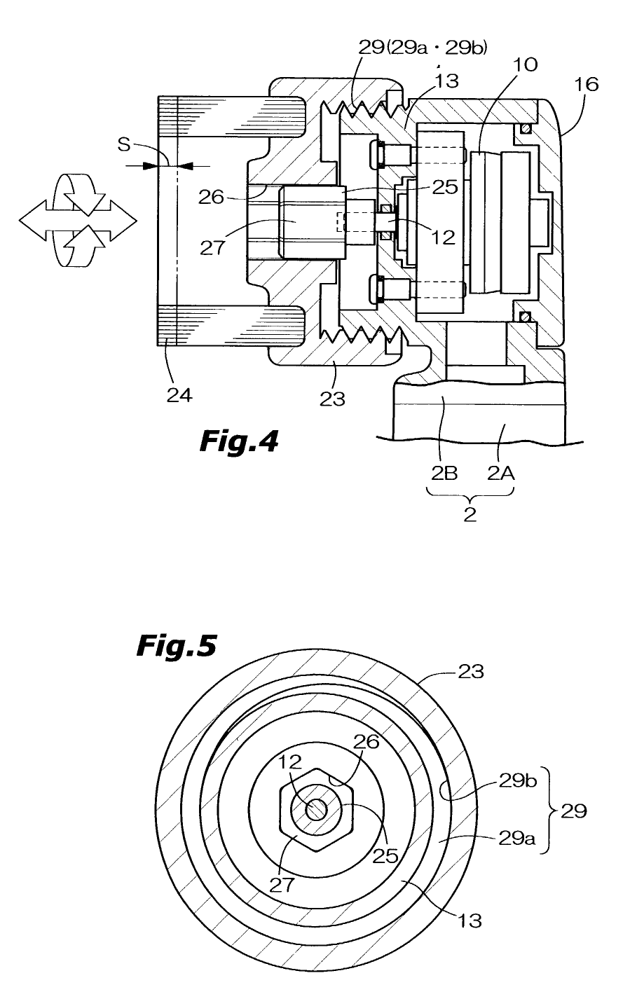

When oscillated in normal and reverse rotational directions, brush body 3 is simultaneously reciprocated in a direction along output shaft 12. For this purpose, a reciprocating mechanism is provided between motor case 2B and holder 23. As shown in FIG. 3, a screw component 29 functions as a motion-converting element in the reciprocating mechanism. Screw component 29 includes a male thread part 29a which is formed on a peripheral surface of juncture member 13 of motor case 2B, and a female thread part 29b which is formed in an inner surface of a rear side of holder 23. Male thread part 29a and female thread part 29b engage with each other. Screw component 29 is a double-start thread. In this construction, while output shaft 12 of ultrasonic motor 10 turns one-half turn, brush body 3 is driven to move forth in a direction along output shaft 12 by one pitch of the thread of screw component 29. In FIG. 4, brush body 3 is reciprocated within stroke length S.

When brush body 3 is mounted to juncture member 13 and connecting piece 25, driving shaft 27 is inserted and engaged into driving aperture 26 while holder 23 is fit to juncture member 13 such that male thread part 29a and female thread part 29b engage with each other. At this time, the inner end of female thread part 29b faces to an end surface of juncture member 13 with a narrow clearance. Due to this constitution, output shaft 12 and brush body 3 synchronously rotate. Output shaft 12 rotates at a 70°-110° angle of rotation. The number of reversal rotations is approximately 1500 per minute under loaded conditions. The angle of rotation is arbitrarily varied in accordance with parameter setting of the control circuit, so that the angle of rotation can be set 300° or more if need be.

When a user turns on ON-button 6, ultrasonic motor 10 oscillates brush body 3 in normal and reverse rotational directions in alternate shifts. At the same time, brush body 3 is reciprocated in backward and forward in alternate shifts along screw component 29. Accordingly, the tip of bristles 24 is simultaneously oscillated and reciprocated. This enables the user to effectively brush every gap between his or her teeth or his or her gum line.

Driving power from ultrasonic motor 10 is directly transmitted to brush body 3 by connecting piece 25. Consequently, contrasted with a conventional constitution that driving power from a motor arranged in casing main body 1 is transmitted to brush body 3 through a driving power transmitting system placed in arm 2, driving power is transmitted without substantial power losses in the embodiments of the present invention. Besides, brush body 3 alone can be replaced, which minimizes costs of replacement parts.

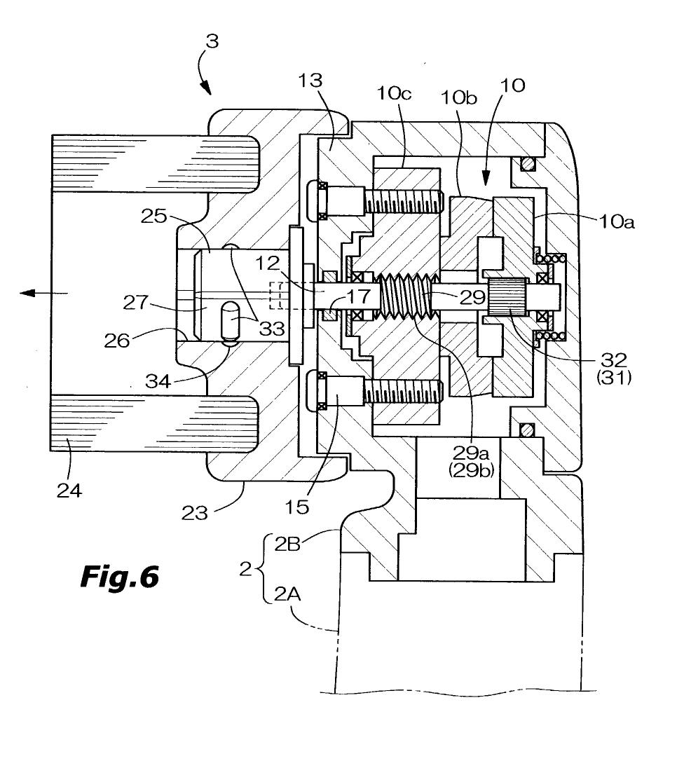

FIG. 6 shows a second embodiment of an electric toothbrush according to the present invention. In the second embodiment, output shaft 12 of ultrasonic motor 10 is simultaneously oscillated and reciprocated. More specifically, a spline hole 31 is provided in a rotor 10a of ultrasonic motor 10 while a spline shaft 32 is provided in output shaft 12 which is connected to rotor 10a, wherein spline hole 31 and spline shaft 32 engage with each other. This enables rotor 10a to rotate output shaft 12.

A reciprocating mechanism is provided between a mounting member 10c of ultrasonic motor 10 and output shaft 12. The reciprocating mechanism allows screw component 29 to function as a motion-converting element, and simultaneously oscillate and reciprocate output shaft 12. Screw component 29 in the second embodiment includes male thread part 29a formed in output shaft 12 and a screw hole having female thread part 29b formed in mounting member 10c. Male thread part 29a engages with female thread part 29b. Mounting member 10c is screwed shut on juncture member 13 by screws 15 as in the case of the first embodiment. Ultrasonic motor 10 further includes a stator 10b.

As is the case with the first embodiment, connecting piece 25 is fixed to output shaft 12, and brush body 3 is detachably fit on connecting piece 25. Driving shaft 27 of connecting piece 25 has engagement ribs 33 while driving aperture 26 of holder 23 has an engagement groove 34. When driving shaft 27 is inserted into driving aperture 26, engagement ribs 33 engage with engagement grooves 34. This keeps brush body 3 being detachably attached to connecting piece 25.

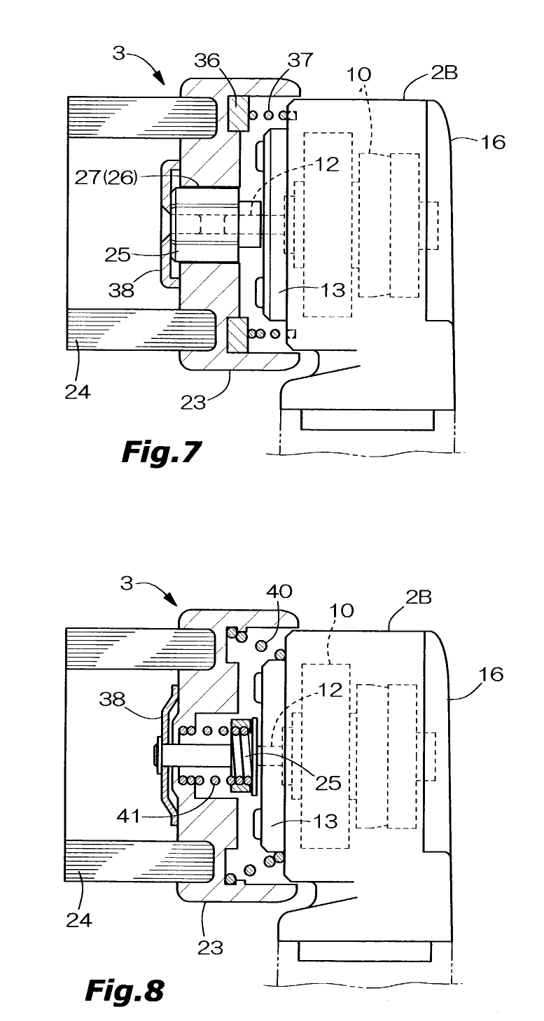

FIG. 7 shows the third embodiment according to the present invention. In the third embodiment, as in the case of the first embodiment, it is constituted in a manner such that brush body 3 is not rotated relative to connecting piece 25 but reciprocated along output shaft 12. Besides, a reciprocating mechanism is provided between holder 23 of brush body 3 and juncture member 13 of motor case 2B.

In the reciprocating mechanism, a ring-shaped oscillator 36 fixed inside holder 23 and an oscillatory spring 37 connecting oscillator 36 and juncture member 13 function as motion-conversion elements. Oscillator 36 is of uneven thickness and uneven weight in a periphery thereof When brush body 3 is oscillated in normal and reverse rotational directions, oscillatory spring 37 including a compressed coil spring is bent and deformed by oscillation of oscillator 36, thereby reciprocating brush body 3 backward and forward to and from juncture member 13. To prevent unwanted separation of brush body 3 from connecting piece 25, a stopper board 38 fixed to the connecting piece 25 receives and supports holder 23.

FIG. 8 shows a fourth embodiment of an electrical toothbrush in accordance with the present invention. In the fourth embodiment, holder 23 is suspended by a supporting spring 40 and spaced from juncture member 13 of motor case 2B of arm 2. In this state, holder 23 is rotatable around and movable along output shaft 12, and rotational force from connecting piece 25 is transmitted to holder 23 through a power-transmission spring 41. In this constitution, power-transmission spring 41 functions as a motion-conversion element in a reciprocating mechanism. One end of transmission spring 41 is fixed to connecting piece 25, and another is fixed to holder 23. In this case, a stopper board 38 fixed to an end surface of connecting piece 25 receives and supports holder 23 to prevent unwanted separation of brush body 3 from arm 2. Supporting spring 40, an end of which is fixed to juncture member 13, supports holder 23 in a predetermined position.

When ultrasonic motor 10 rotates brush body 3 into a certain direction, power-transmission spring 41 is tightened and rotated into the rotating direction of brush body 3, and brush body 3 is drawn so as to approach juncture member 13. Then, when ultrasonic motor 10 rotates brush body 3 into the reverse direction, power-transmission spring 41 is loosened and rotated, and brush body 3 is pushed away from juncture member 13. Repeating this movement makes three-dimension driving of brush body 3.

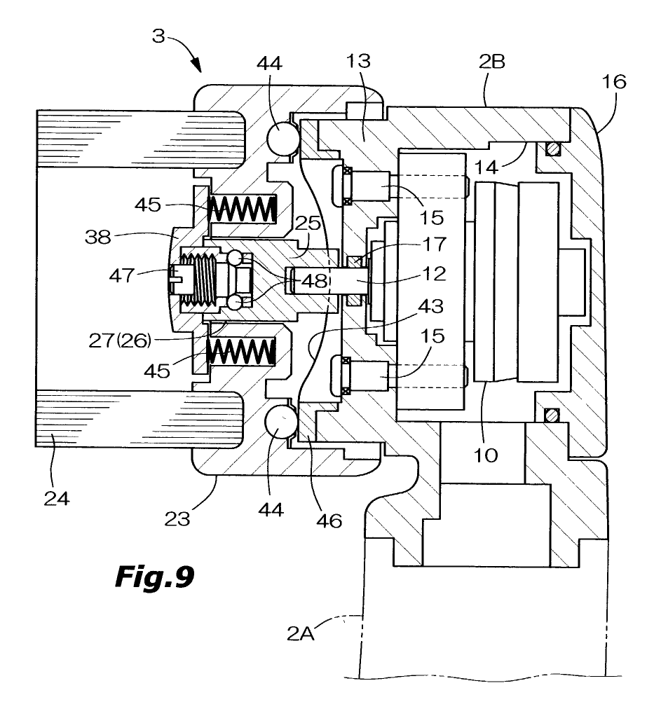

FIG. 9 shows a fifth embodiment of an electric toothbrush in accordance with the present invention. In the fifth embodiment, a cam 43 and a cam follower 44 function as motion-conversion elements in a reciprocating mechanism. The mechanism includes a pair of compressed coil springs 45, which are arranged between stopper board 38 fixed on the connecting piece 25, and holder 23. Spring 45 presses and urges holder 23 against juncture member 13. Cam 43 is formed with a cam ring 46 which is fixed to an end surface of juncture member 13. Cam 43 includes raised parts and fallen parts which are alternately formed at 90° intervals. Cam follower 44 includes a pair of steel balls which are arranged at higher and lower positions inside brush holder 23. When cam follower 44 rolls along cam 43, brush body 3 moves back and forth to and from juncture member 13. The structure also includes a locking screw 47 for keeping brush body 3 connected to connecting piece 25. Loosening locking screw 47 releases locking balls 48 and allows brush body 3 to be detached from connecting piece 25. It is noted other components are substantially the same as those described in the first embodiment, but which have been omitted to avoid unnecessary redundancy.

In the first embodiment through the fifth embodiment, a square shaft or a D-section shaft can also be used as driving shaft 27 and spline shaft 32, and a flexible shaft can also be used as power-transmission spring 41 depicted in FIG. 8. A reciprocating mechanism can also be constituted in a manner such that projections formed on holder 23 and juncture member 13 face and support each other. The reciprocating mechanism that screw component 29 functions as a motion-conversion element can also be constituted such that casing main body 1 has a button for continuously rotating output shaft 12 in certain directions, wherein a user switches the button for rotating output shaft 12 in a certain direction thereby attaching brush body 3, or for rotating output shaft 12 in the reverse rotation thereby detaching brush body 3. It is also possible to make a constitution that brush body 3 is directly connected to output shaft 12. Ultrasonic motor 10 can also be driven by a commercial power source.

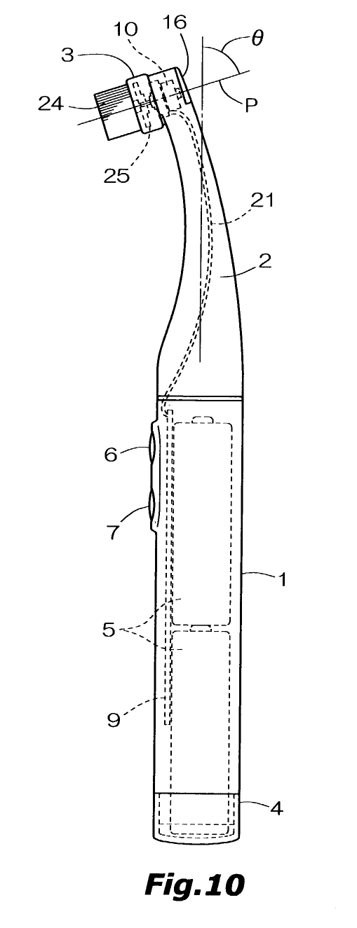

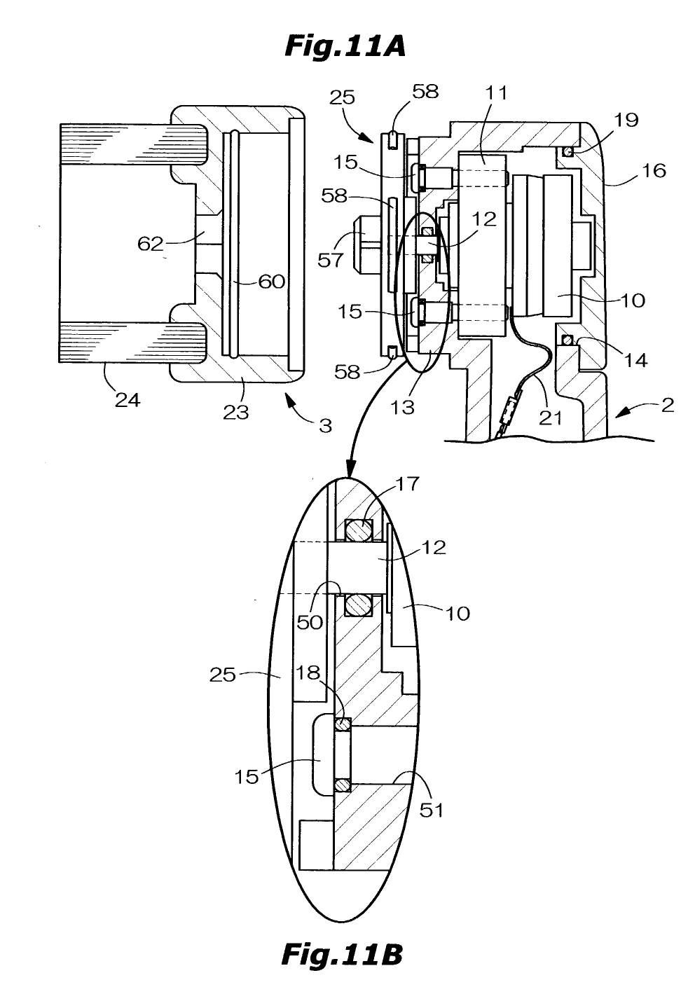

FIGS. 10-14 show an electric toothbrush according to the sixth embodiment of the present invention. Referring to FIG. 10, the electrical toothbrush includes casing main body 1 performing as a grip, arm 2 extending above casing main body 1, and brush body 3 which is fit on an upper front surface of arm 2.

Casing main body 1 includes a hollow-body plastic molding formed in a cylinder shape, and its upper and lower ends are open. A proximal end of arm 2 is water-tightly fixed on an upper end of casing main body 1. A lower end of casing main body 1 is open but watertightly closed by battery lid 4. Casing main body 1 also contains plural batteries 5 and circuit board 9 on which a control circuit is mounted. A user can attach and detach battery lid 4 to and from casing main body 1 for replacing batteries 5. Casing main body 1 is also provided in its upper front surface with ON-button 6 for switching on a current-carrying circuit and OFF-button 7 for switching off the current-carrying circuit. Primary batteries or secondary batteries can be used as batteries 5.

Arm 2 is a plastic molding formed like a cylinder. Ultrasonic motor 10 for driving brush body 3 is also arranged in a top part of arm 2. Ultrasonic motor 10 oscillates brush body 3 in normal and reverse rotational directions. Juncture member 13 for fixing ultrasonic motor 10 is also arranged in a manner of protruding from a top front surface of arm 2. Output shaft 12 of ultrasonic motor 10 sticks out of juncture member 13.

Ultrasonic motor 10 is incorporated inside arm 2 through loading gate 14 which is arranged in a rear side of arm 2. Thus, flange 11 of ultrasonic motor 10 is applied to an inner surface of juncture member 13, and screws 15 are screwed from outside of the front surface of juncture member 13. Screws 15 tighten flange 11 onto the inner surface of juncture member 13, thereby fastening ultrasonic motor 10.

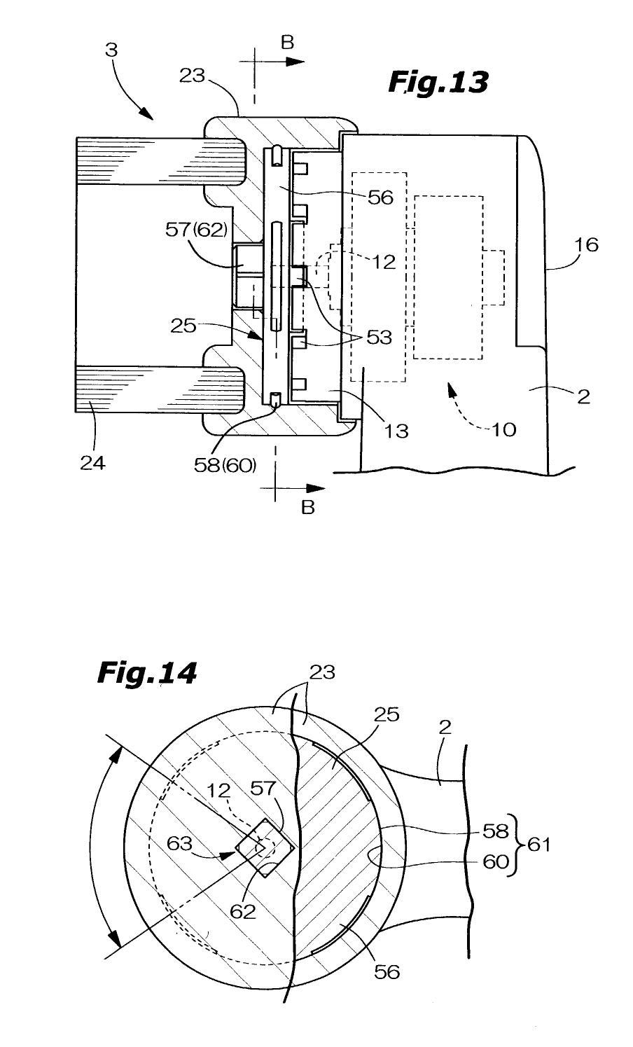

In the above-mentioned state, first gaskets 17 tightly seal spaces between shaft 12 and shaft hole 50 which is formed on juncture member 13 and in which shaft 12 is inserted. Second gaskets 18 tightly seal spaces between screws 15 and screw holes 51 which are formed on juncture member 13 and in which screws 15 are screwed. Third gaskets 19 fixed on cover 16 seal spaces between loading gate 14 and cover 16 covering loading gate 14. To prevent unwanted separation, cover 16 is adhesively fixed to loading gate 14. Ultrasonic motor 10 and circuit board 9 are connected to each other by lead 21. Referring to FIG. 13, juncture member 13 includes grooves 53 which are provided at regular intervals on a wall surrounding screws 15. This constitution makes it easier to discharge water that entered into spaces between connecting piece 25 and juncture member 13.

Brush body 3 includes plastic holder 23 formed like a cylinder and bristles 24 which are planted in a ring shape. Holder 23 is detachably connected to shaft 12 of ultrasonic motor 10 by connecting piece 25.

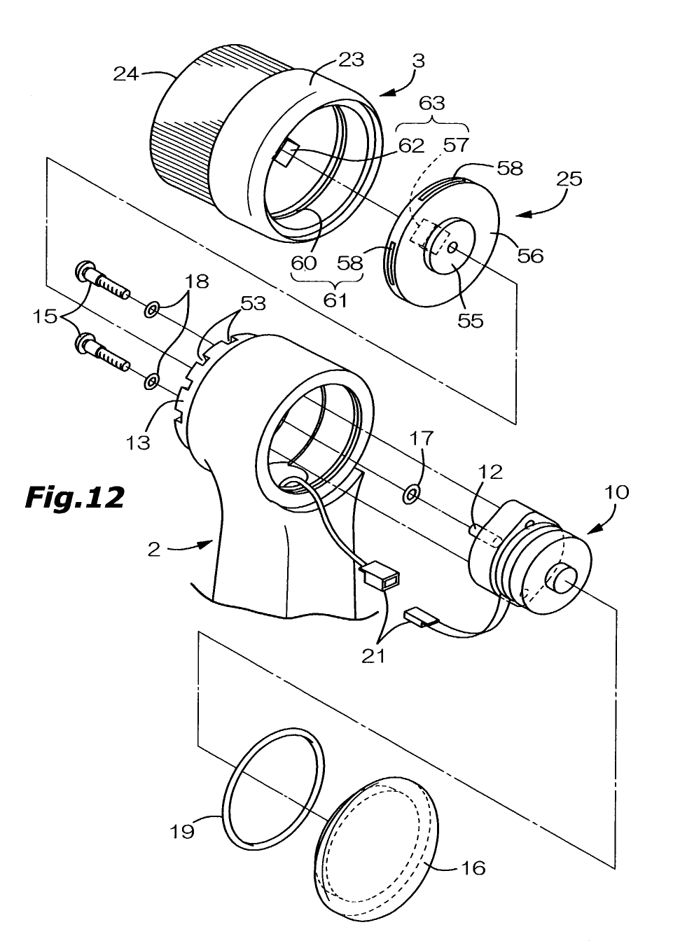

Referring to FIG. 12, connecting piece 25, made of plastic, includes a boss 55, which is fixed to shaft 12 and not rotated relatively to shaft 12, a flange 56 larger than boss 55, and a square shaft 57. To prevent unwanted separation of holder 23 from connecting piece 25, there is provided stopper 61 comprising four ribs 58 which are formed on a peripheral surface of flange 56, and a peripheral groove 60 which is formed on an inner surface of holder 23. Square shaft 57 of connecting piece 25 and square hole 62 which goes through a center of holder 23 compose a power-transmission structure 63. Square shaft 57 and square hole 62 engage with each other, which makes synchronous rotation of holder 23 and connecting piece 25.

Referring to FIG. 13, the user uses the electric toothbrush with brush body 3 connected to connecting piece 25. When the user turns on ON-button 6, ultrasonic motor 10 oscillates brush body 3 at angles of 70°-110°, and the number of reversal rotations is approximately 1500 per minute under loaded conditions (refer to FIG. 14). Driving power from ultrasonic motor 10 is directly transmitted to brush body 3 by connecting piece 25. Consequently, contrasted with a constitution that driving power from a motor is transmitted through a driving power transmitting system, driving power is transmitted without substantial power losses in the presented embodiments of the present invention, which makes it possible to reduce power consumption of batteries 5.

If only plural brush bodies 3 are prepared, plural users can share the electric toothbrush. When the user turns off OFF-button 7 after use, ultrasonic motor 10 is shut off.

As shown, arm 2 is curved toward a projecting direction of brush body 3, and a central axis P of brush body 3 is oriented downward with a slant. More concretely, as shown in FIG. 10, angle θ between central axis P and a longitudinal centerline of casing main body 1 is 68°. This structure enables the user to easily brush his or her teeth in a relaxed posture without widely opening his or her mouth.

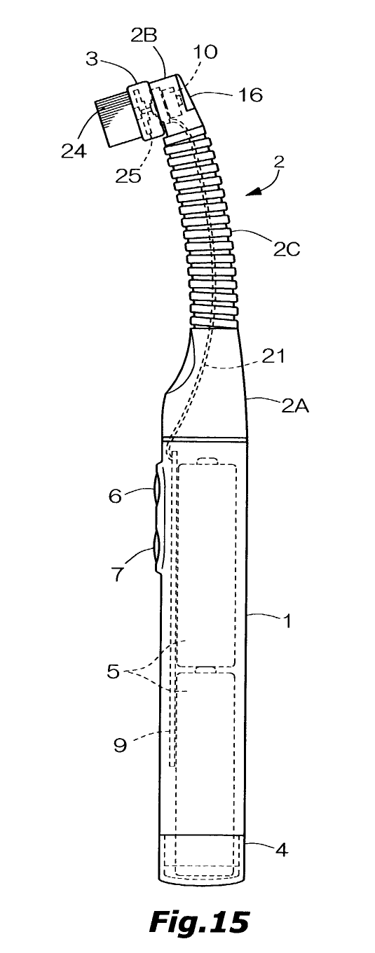

FIG. 15 shows the seventh embodiment of the present invention. Arm 2 includes hollow short arm base 2A which is fixed to casing main body 1, motor case 2B for containing ultrasonic motor 10, and flexible arm 2C which is placed between arm base 2A and motor case 2B. Flexible arm 2C is formed in a hollow cylindrical shape in which lead 21 runs.

As described above, since arm 2 includes flexible arm 2C in its middle part, the user can bend flexible arm 2C by holding motor case 2B and casing main body 1 by hand for varying a curve of arm 2, thereby easily adjusting the angle of brush body 3. It is noted other components are substantially the same as those described in the first embodiment but which have been omitted to avoid unnecessary redundancy.

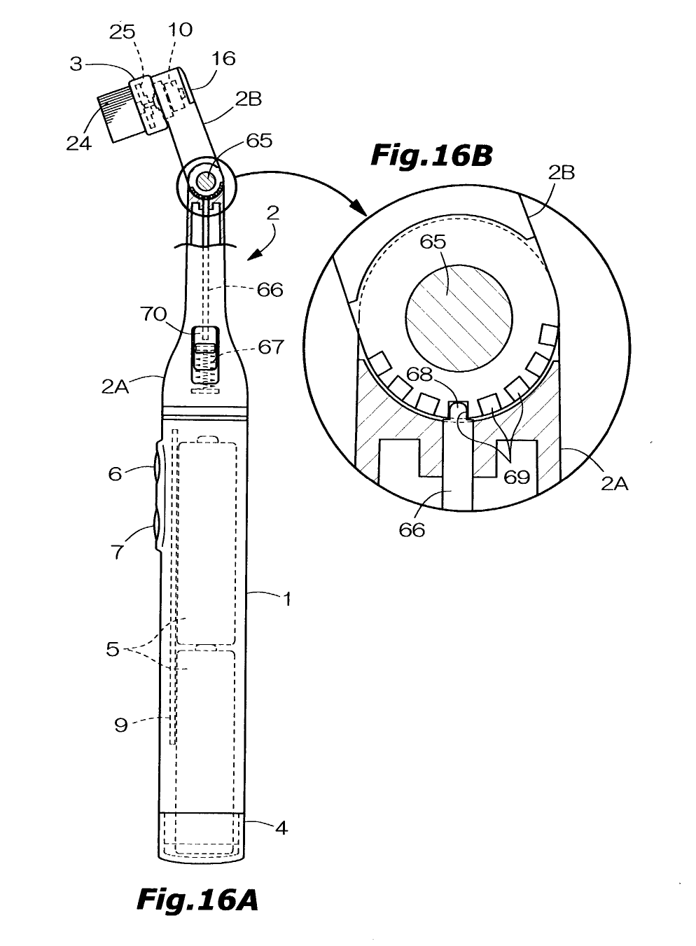

FIGS. 16A and 16B show an eighth embodiment of the present invention. In this embodiment, arm 2 includes long straight arm base 2A which is fixed to casing main body 1 and motor case 2B which contains ultrasonic motor 10. Lower end of motor case 2B is connected to a top end of arm base 2, and motor case 2B can be tilted forward and backward via horizontal axis 65.

Arm base 2A contains a locking member 66 which securely locks motor case 2B at a certain arbitrary angle in a manner of preventing unwanted tilting of motor case 2B. Long straight locking member 66, which is supported by arm base 2A and urged upward by spring 67, is slidable upward and downward. Locking member 66 includes an engaging part 68 in a top end thereof. Engaging part 68 engages with one of engaging grooves 69 which are arranged on lower peripheral surface of motor case 2B. Thus, motor case 2B can securely be locked without unwanted tilting. A lever 70 is disposed on an outside surface of arm base 2A. When the user presses lever 70 down against urging force of spring 67, locking member 66 releases motor case 2B.

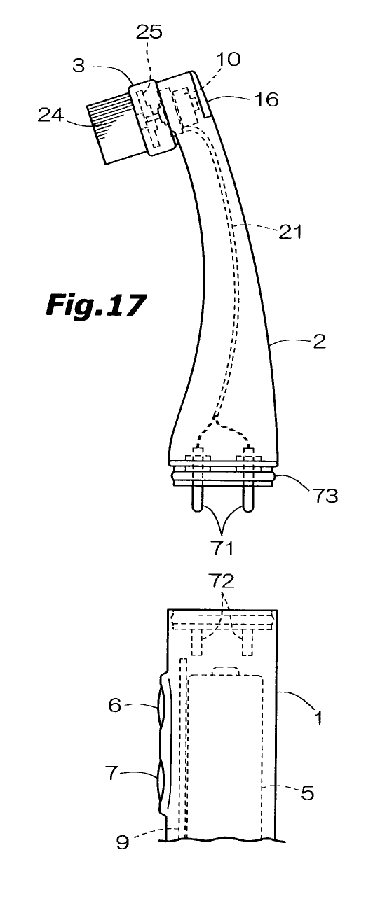

FIG. 17 shows a ninth embodiment of the present invention. A lower end of arm 2 of this embodiment is detachably attached to a top end of casing main body 1. Arm 2 and casing main body 1 are electrically connected to each other through male connectors 71 and female connectors 72 which are respectively provided in arm 2 and casing main body 1. Waterproof gasket 73 tightly seals a space between casing main body 1 and arm 2.

As to flexible arm 2C in FIG. 15, a round hollow shape is not necessarily required, but another shape is also applicable. Further, for example, a composition that arm base 2A and casing main body 1 are formed in a united member, and a lower end of flexible arm 2C is fixed to a top end of casing main body 1, is also applicable.

The sixth embodiment through the ninth embodiment can also apply a composition that circuit board 9 is placed in a space inside arm 2. In such a composition, circuit board 9 is composed of a flexible printed-circuit board on which electric parts are mounted, so that circuit board 9 can be arranged along a curved shape of arm 2.

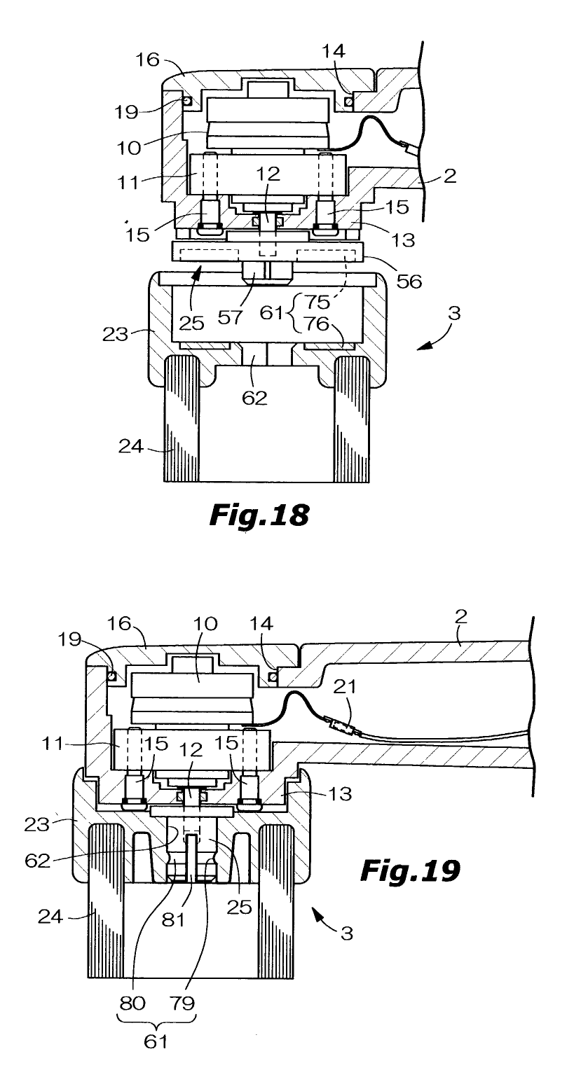

According to a tenth embodiment of the present invention, FIG. 18 shows connecting structure between brush body 3 and connecting piece 25. Stopper 61 for preventing unwanted separation of holder 23 from arm 2 includes a ring-shaped magnet 75 which is embedded on an end surface of flange 56 of connecting piece 25 and an attractive piece 76 of a magnetic metal plate which is inserted in a bottom of holder 23. It is noted other components are substantially the same as those described in the sixth embodiment but which have been omitted to avoid unnecessary redundancy.

According to an eleventh embodiment of the present invention, FIG. 19 shows a connecting structure between brush body 3 and connecting piece 25. As shown, the structure includes connecting piece 25 which is formed in a square shank, an engagement rib 79 which is arranged on inner surface of a square hole 62 which is formed in holder 23, and an engagement groove 80 which is arranged on a peripheral surface of connecting piece 25. In this structure, engagement rib 79 and engagement groove 80 engage with each other, thereby composing stopper 61. The square shank of connecting piece 25 has a slit 81 for detaching brush body 3.

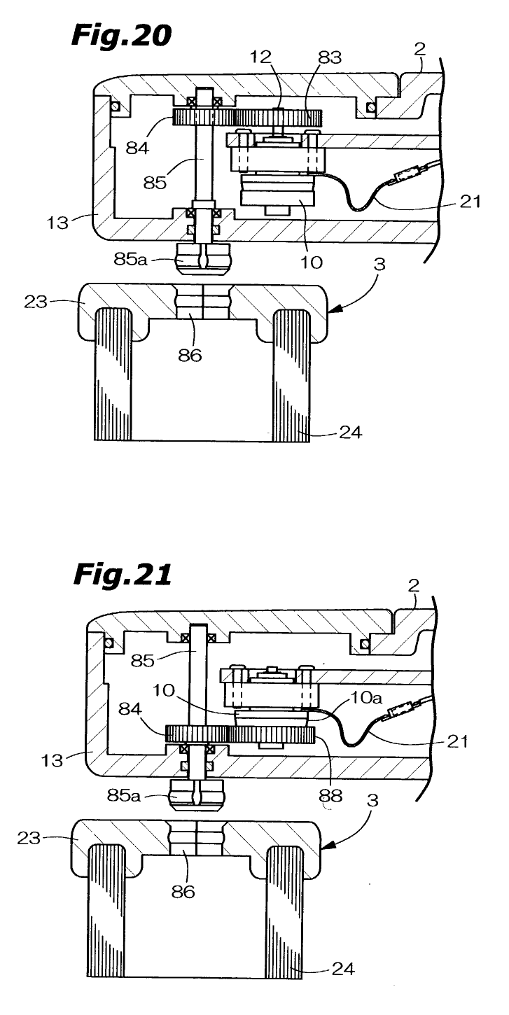

In accordance with the present invention, FIG. 20 shows a twelfth embodiment where a driving gear 83 is unitedly connected to output shaft 12 of ultrasonic motor 10 which is mounted in juncture member 13 of arm 2. Juncture member 13 is furnished with a rotatable shaft 85 having a driven gear 84 which meshes with a driving gear 83. Shaft 85 is supported in a manner so as not to be separated from juncture member 13. An end of shaft 85 is projected out of juncture member 13 as a projected part 85a. Projected part 85a of shaft 85 is inserted into an engagement hole 86 which is formed on holder 23 of brush body 3 in a manner such that projected part 85a does not rotate relative to holder 23. The user can detach brush body 3 from shaft 85 through a latching which is composed of projected part 85a and engagement hole 86. In the twelfth embodiment, ultrasonic motor 10 oscillates brush body 3 in normal and reverse rotational directions via driving gear 83 and shaft 85.

FIG. 21 shows a thirteenth embodiment of the present invention. Contrasted with the above-mentioned twelfth embodiment where driving gear 83 is disposed in output shaft 12 of ultrasonic motor 10, the thirteenth embodiment applies a composition that a driving gear 88 meshing with driven gear 84 is formed on a peripheral surface of rotor 10a of ultrasonic motor 10.

The twelfth embodiment and the thirteenth embodiment can also apply a composition where shaft 85 having gear grooves is unitedly formed in holder 23 of brush body 3 so as to allow driving gears 83 and 88 to mesh with shaft 85 without driven gear 84. In such a composition, brush body 3 including shaft 85 can be detached from juncture member 13.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An electric toothbrush, comprising:
a casing main body which a user holds;
an arm which extends above said casing main body;
a brush body which is arranged in a top front side of said arm;
an ultrasonic motor which is arranged in a top end inside said arm; and
a reciprocating mechanism which is arranged between said arm and said brush body and which is adapted to oscillate said brush body in normal and reverse rotational directions and to simultaneously reciprocate said brush body in a direction along an output shaft of said ultrasonic motor.

2. The electric toothbrush according to claim 1, wherein said casing main body contains batteries for supplying power to said ultrasonic motor, and
wherein said casing main body includes changeover buttons for switching on and off a current carrying circuit of said ultrasonic motor.

3. The electric toothbrush according to claim 1,
wherein said brush body comprises a holder and bristles which are planted in a front side of the holder;
wherein said holder is connected to the output shaft of said ultrasonic motor and movable in a direction along the output shaft;
wherein said arm comprises a juncture member for mounting said ultrasonic motor; and
wherein said reciprocating mechanism, which is provided between said juncture member arranged in said arm and the holder arranged in said brush body, has a screw component for engaging said juncture member and brush body as a motion conversion element.

4. The electric toothbrush according to claim 1,
wherein said output shaft is connected to a rotor included in said ultrasonic motor in a manner such that the output shaft is movable in a direction along the output shaft; and
wherein said reciprocating mechanism is provided between said output shaft and said arm, and the screw component for engaging the output shaft and the arm is adapted to perform as a motion conversion element.

5. The electric toothbrush according to claim 1,
wherein said brush body comprises a holder and bristles which are arranged in a front side of the holder;
wherein said brush body is connected to the output shaft of said ultrasonic motor in a manner such that said brush body is movable in a direction along the output shaft; and
wherein said reciprocating mechanism includes an oscillator which is fixed in the holder, and an oscillatory spring which is arranged between a juncture member provided in said arm for mounting said ultrasonic motor, and the oscillator, wherein said oscillator and said oscillatory spring function as motion conversion elements.

6. The electric toothbrush according to claim 1,
wherein said brush body is supported by said arm in a manner such that said brush body is rotatable around and movable in a direction along the output shaft;
wherein said reciprocating mechanism includes a power transmission spring which is tightenable and rotatable in a direction along the output shaft of said ultrasonic motor, said power transmission spring function as a motion conversion element; and
wherein said brush body is connected to the output shaft through the power-transmission spring.

7. The electric toothbrush according to claim 1,
wherein said brush body includes a holder and bristles which are planted in a front side of the holder;
wherein said brush body is connected to the output shaft of said ultrasonic motor by a connecting piece in a manner such that said brush body is movable in a direction along the output shaft;
wherein said arm comprises a juncture member for mounting said ultrasonic motor;
wherein said reciprocating mechanism includes a cam which is arranged in the juncture member of said arm and a cam follower which is arranged in the holder of said brush body, said cam and said cam follower functionable as motion-conversion elements;
wherein a stopper board for preventing unwanted separation of said brush body from said arm is fixed in a top end of the connecting piece; and
wherein a spring for pressing and urging said brush body against the cam is arranged between the stopper board and the holder of said brush body.

8. The electric toothbrush according to claim 1,
wherein the connecting piece is fixed in the output shaft of said ultrasonic motor;
wherein said brush body is detachably attached to the connecting piece; and
wherein the connecting piece is provided with a driving shaft which is engagable with a driving hole arranged in said brush body so that said brush body is movable in a direction along the output shaft.

9. An electric toothbrush, comprising:
a casing main body which a user holds;
an arm which extends above said casing main body;
a brush body which is arranged in a top front side of said arm; and
an ultrasonic motor which is arranged in a top end inside said arm and which is adapted to oscillate said brush body in normal and reverse rotational directions;
wherein said arm is curved toward a direction which said brush body is projected.

10. The electric toothbrush according to claim 9, wherein said brush body has a central axis which is oriented downward with a slant.

11. The electric toothbrush according to claim 9,
wherein a connecting piece, which is drivable by said ultrasonic motor, is provided in a top end of said arm, and
wherein said brush body is detachably attached to said connecting piece.

12. The electric toothbrush according to claim 9,
wherein said arm includes a flexible arm, which is bendable, and a motor case which is fixed to a top end of said flexible arm and which contains said ultrasonic motor.

13. The electric toothbrush according to claim 9,
wherein said arm comprises an arm base which is fixed to said casing main body, and a motor case for containing said ultrasonic motor,
wherein said motor case is connected to a top end of the arm base in a manner such that the motor case is tiltable forward and backward via a horizontal axis; and
wherein said arm base further includes a locking member which operatively locks the motor case at an arbitrary angle.

14. The electric toothbrush according to claim 9, wherein said arm is detachable and attachable from and to said casing main body.

15. An electric toothbrush, comprising:
a casing main body which a user holds;
an arm which extends above said casing main body;
a brush body which is arranged in a top front side of said arm;
an ultrasonic motor which is arranged in a top end inside said arm, and which is adapted to oscillate said brush body in normal and reverse rotational directions; and
a connecting piece which is fixed to an output shaft of said ultrasonic motor,
wherein said brush body is detachably attached to said connecting piece.

16. The electric toothbrush according to claim 15, further comprising:
a power transmission structure which is arranged between said connecting piece and said brush body and which operatively transmits rotational motions from the output shaft of said ultrasonic motor to said brush body; and
a stopper which supports said brush body to operatively prevent unwanted separation of said brush body from said arm.

17. The electric toothbrush according to claim 15,
wherein said arm includes a juncture member, which is located in a front side for mounting said ultrasonic motor, and a loading gate which is located in a rear side;
wherein said ultrasonic motor is incorporated inside said arm through the loading gate and secured in the juncture member by screws which are screwable from outside of the juncture member;
wherein spaces between the output shaft of said ultrasonic motor and the juncture member are sealable by a first gasket;
wherein spaces between the screws and the juncture member are sealable by a second gasket; and
wherein spaces between a cover for covering the loading gate and the loading gate are sealable by a third gasket.

18. A method of using the electric toothbrush comprising utilizing the electric toothbrush of claim 1.

19. A method of making the electric toothbrush comprising making the electric toothbrush of claim 1.

20. An electric toothbrush comprising:
a casing adapted to be operatively held by a user,
an arm extending above the casing;
a brush body being arranged at a top side of the arm,
an ultrasonic motor being arranged inside a top end of the arm, and
a reciprocator for oscillating the brush body in normal and reverse rotational directions.

21. The electric toothbrush according to claim 20, wherein the brush body is operatively reciprocable in a direction along an output shaft of the motor.

22. The electric toothbrush according to claim 20, wherein the arm is curved toward a direction which the brush body is projecting.

23. The electric toothbrush according to claim 20, wherein the toothbrush further comprises a connecting piece fixed to an output shaft of the motor, said brush body being detachable from the connecting piece.
